(19) United States
(12) Patent Application Publication
(10) Pub. No.: US 2015/0236754 A1
(43) Pub. Date: Aug. 20, 2015

(54) MEANS FOR TRANSMITTING DATA IN A UNIDIRECTIONAL OR BIDIRECTIONAL MANNER

(71) Applicant: Touchpac Holdings, LLC, New York, NY (US)

(72) Inventors: Sven Hofmann, Leipzig (DE); André Kreutzer, Mittweida (DE)

(73) Assignee: Touchpac Holdings, LLC, New York, NY (US)

(21) Appl. No.: 14/468,007

(22) Filed: Aug. 25, 2014

Related U.S. Application Data
(63) Continuation of application No. 14/126,765, now abandoned.
(60) Provisional application No. 61/497,620, filed on Jun. 16, 2011.

(30) Foreign Application Priority Data
Jun. 16, 2011 (EP) 11170249.4

(51) Int. Cl. H04B 5/00

(52) U.S. Cl. CPC H04B 5/0012

(57) ABSTRACT

In some embodiments, a system is provided for transmitting data between a device having a touch screen and a transmitting and/or receiving device. The touch screen may be a capacitive screen and the device may have at least one plate having at least one electrically conductive area, wherein the plate is operatively connected to the touch screen and at least one area is activated.

### RELATED APPLICATIONS

This application is a continuation of U.S. application Ser. No. 14/126,765, filed Dec. 16, 2013, which is a U.S. National Stage application based on International Application PCT/EP2012/061593, filed Jun. 18, 2012, which claims priority to U.S. Provisional Application No. 61/497,620, filed Jun. 16, 2011 and European Application No. 11170249.4, filed Jun. 16, 2011, all of which are incorporated herein by reference in their entireties.

### BRIEF DESCRIPTION OF DRAWINGS

In the text which follows, the invention will be explained by way of example by means of figures, without however being restricted to these. In the figures:

FIG. 1 shows a preferred system

FIG. 2A, B show interaction between a device and the device

FIG. 3 shows a sectional view of a plate

FIG. 4 shows the transmitting and receiving device having a number of sensors distributed in the device

FIG. 5 shows a system having a number of conductive areas arranged on the plate

FIG. 6A, B show unidirectional and bidirectional data exchange

FIG. 7 shows preferred transmitting and/or receiving device with a cover layer

FIG. 8 shows the preferred data exchange

FIG. 9 shows the preferred sequence of a data exchange

### DETAILED DESCRIPTION

The invention relates to a system for transmitting data between a device having a touch screen and a transmitting and/or receiving device. The invention also relates to the use of the system and to a method for data transmission.

In the digital age, the smart phone or another portable electronic device becomes a constant companion which is increasingly burdened with further tasks apart from the original ones. An essential task of the devices is the administration of data such as, for example, contact data, access data, notices but also financial data which, for example, allow the bank account to be administered whilst mobile. It is also possible to use the device for buying goods or services.

It is therefore necessary to provide for this digital companion a device which provides for communication with the devices and achieves reliable, fast and complex data exchange with the electrical device. Data exchange is a term from electronic data processing and designates in particular the transmission of data between electrical devices such as, for example, computers, system components or programs.

In the prior art, the so-called “near field communication” (NFC) is described which represents standardized standard for the transmission of data in the near field, that is to say over a short distance of a few centimeters. In this context, the transmission is not by cables but wireless.

Data transmissions by NFC are in most cases intuitive, which means an NFC-capable device such as, e.g., an NFC mobile telephone is simply held close to another NFC device or a data medium (e.g. a so-called NFC tag) on which information is stored. Following this, the data transmission and possibly the associated application starts automatically and/or after a brief confirmation by pressing a button.

In this context, a maximum transmission rate of 424 kBit/s can be achieved. The data transmission is by NFC and thus, although it is slower than in the case of related techniques such as Bluetooth or WLAN, it also offers decisive advantages in the subject of security. This makes NFC to be the base for cashless payment systems or access controls.

The data can be transmitted both unidirectionally and bidirectionally, that is to say connected devices can exchange data in both directions and thus conduct a dialog. NFC technology makes it possible, for example, to carry out transactions of various types, exchange digital contents or connect electronic devices to one another.

In principle three different modes of NFC data transmission are distinguished:
Reading out of information stored in a passive memory by means of an NFC device. E.g. transmission of a concert date from an NFC tag attached to a poster for storage and as reminder on an NFC mobile telephone.
Reading out of information from an NFC terminal by an active NFC medium. For example the reading out of the electronic concert ticket stored on an NFC mobile telephone by an NFC terminal in the entry area.
Bidirectional exchange of data between two NFC devices in dialog.

Furthermore, various methods for protection against manipulation of transactions are known from the prior art. In the electronic performance of banking transactions, in particular, the use of the PIN/TAN method is applied in different forms. In this arrangement, a user logs in on the bank server of his bank via a PIN by means of his browser and conveys the transaction data of the transaction to be performed via a corresponding data link which is preferably cryptographically secured.

In the printed document WO 2008/046575 A1, a method for performing an application with the aid of a portable data medium is described in which the application is performed with the aid of a first and second terminal with interposition of the data medium. In particular, the method can also be used for carrying out electronic bank transactions. The communication performed in this process always takes place with interposition of the portable data medium. In the method, transaction data are input first via the first terminal, the first terminal being, in particular, a personal computer. Following this, the data are conveyed to the portable data medium which forwards them to a second terminal, e.g. to a mobile telephone. The transaction must then be enabled by a user by means of an input at the second terminal, whereupon the transaction data are transferred from the data medium to a server which executes the transaction. In the printed document US 2003/0087601 A1, the use of a security token having two interfaces for the secure data transmission between a mobile telephone and a PC is described. In this arrangement, the token communicates via a contactless interface, for example based on Bluetooth or infrared, with the mobile telephone and via a contact-connected interface with the PC.

Furthermore, it is disclosed in the prior art that portable data media can be equipped with a chip and data-medium or personal data can be stored on this chip. However, the writing-in of the data is only possible via a suitable data communication link from a writing facility located outside the data medium to the embedded chip. In this context, it is known to provide contact areas on the outside of portable data media, via which data-medium or personal data (e.g. personalization data) can be written into the chip of the data medium. Such data-medium-individual or personalized data relate to individualizing data of a person or of a data medium configuration or the like which cannot be played in during the initialization of the data medium since, in particular, they are not data-medium- and/or person-independent data suitable for a multiplicity of data media. For this purpose, the data-medium- or person-individual data are written into the chip completely embedded in a plastic substrate via a contact field of the data medium.

Such contact fields are optically noticeable and create a basic access to the sensitive data in the chip over the entire life of the data medium, which access could be utilized for manipulations and reconnaissance attempts. In addition, they reduce the life of the chip since external influences such as, e.g., electrostatic voltages or discharges may pass directly into the chip or even destroy it. Similarly, the problem arises that such electronically personalized data media, i.e. data media provided with personalization data, can subsequently not easily be allocated to an optical personalization—i.e. a visible individualizing lettering or embossing since the personalization data written into the chip can only be read out with difficulty during the optical personalization.

For example, DE 195 00 925 A1 discloses a chip card for contactless data transmission which, however, is provided with contact areas on its outsides so that here, too, the abovementioned disadvantages in association with the personalization occur.

In the prior art, numerous electronic devices are described which have a touch-sensitive screen (touch screen) which can be operated with fingers or input devices. Touch screens are found in almost all fields of life today. Due to their intuitive operation, they facilitate the easy operation of technical devices in the everyday world especially for inexperienced users and can be used for operating an electronic device. That is to say they can be used both every day and in industry in which touch screens are used, for example, for controlling machines, or in the area of the games industry where they are used for gaming machines or arcade games. Further examples of touch screens comprise smart phones, mobile telephones, displays, tablet PCs, tablet notebooks, touchpad devices, graphic tablets, television sets, PDAs, MP3 players and/or other input devices.

A touch screen can also be a component of input devices. Such input devices are used in, among other things, smart phones, PDAs, touch displays or notebooks.

In general, a touch screen, also called sensor screen, is understood to be a touch-sensitive layer applied to the screen which reacts to contact of the user with his finger or a suitable pointing stylus depending on the technology used. The touch screen is an input device having a direct effect, that is to say the input occurs directly in the displayed space, not remote from the display as would be the case, for example, with a mouse or a keyboard. In addition, the positioning is absolute with a touch screen, that is to say it is not dependent on the preceding position. In consequence, touch screens provide an extremely intuitive operation since the screen serves at the same time as user interface and it is not necessary to select the detour via external input devices.

The touch screens are based on different principles of operation, resistive and capacitive technologies being the most widely used. Resistive touch screens consist, for example, of two mutually opposite transparent conductive ITO (indium tin oxide) layers which are separated from one another by numerous insulated spacers, so-called spacer dots. The inner ITO layer is located, for example, on a solid glass screen, the outer layer is protected by a flexible scratchproof plastic foil.

By means of a control device, a voltage is alternately applied to the conductive layers so that, e.g. a voltage gradient is generated in the X direction on the inner layer and, e.g., a voltage gradient is generated in the Y direction on the outer layer. As soon as the screen is touched, the upper layer is pressed onto the one lying underneath and thus an electrical contact is established and, by means of the respective voltage-less layer on the voltage-carrying layer, a voltage divider is formed, the magnitude of which results from the position of the contact point on the voltage-carrying layer. From this, the corresponding X and Y coordinates of the contact point can be calculated.

In the capacitive technology, in contrast, a multiplicity of conductor tracks extending in parallel with one another of conductive material is in each case applied for example on two spatially separate planes such as, e.g., a top and underside of a foil or of a glass substrate. At the points of intersection of the horizontal conductor tracks of one plane and the vertical conductor tracks of the other plane, capacitances form.

The electrical activation of the conductor tracks of one plane (transmitting lines) generates a measurable signal on the conductor tracks of the second plane (receiving lines). A touch of the system by a user, e.g. via his finger, influences the capacitive coupling between transmitting and receiving lines so that the signal of the receiving line is changed. Subsequently, the resultant signal changes are evaluated and, by means of the respective transmitting and receiving lines, the coordinates of the touch are determined. Apart from a single touch, multi-touch detections are also possible so that several fingers or input elements can trigger a touch event.

Furthermore, touch screens are known which use infrared technology, area acoustic wave technology or dispersive signal technology.

Accordingly, it is the object of the invention to provide a means which does not have the disadvantages or defects of the prior art and provides for secure data transmission by means of a mobile device.

The object of the invention is achieved by the independent claims. Preferred embodiments are found in the subclaims.

A system for transmitting data between a device having a touch screen and a transmitting and/or receiving device is provided, the touch screen being a capacitive screen and the device having at least one plate having at least one electrically conductive area, the plate being or going to be operatively connected to the touch screen and at least one area being or going to be activated. The plate can be designated as medium, flexible or rigid, planar substrate or substrate layer, in particular, in the sense of the invention. The terms will be used synonymously in the application so that a term “plate” used also designates a medium, a flexible or rigid, planar substrate or a substrate layer. It may be preferred that the transmitting and/or receiving device is activated, for example, by the device having the touch screen and a data transmission takes place only after activation. The activation can take place, for example, by means of optical, acoustic, electrical, haptic or tactile signals or means.

It was completely surprising that the system according to the invention does not have the disadvantages and defects of the prior art and provides for an efficient and particularly secure data transmission by means of a touch screen. The speed with which the data are transmitted was especially surprising. This makes it possible to minimize waiting times of users considerably, which considerably improves the operating comfort. Data transmission can be advantageously unidirectional or bidirectional. The transmitting and/or receiving device can transmit data to a touch screen or to a device having a touch screen and/or also receive data from it. In the sense of the invention, unidirectional means especially that the data exchange takes place in only one direction, that is to say either from the transmitting and/or receiving device to the touch screen or the device or conversely. In contrast, bidirectional means in the sense of the invention especially that a data exchange takes place preferably simultaneously or successively in both directions.

In the sense of the invention, data are formations of characters or continuous functions which due to known or implied agreements represent information primarily for the purpose of processing and as its result. The data or information items are (machine) readable and processable and can be used for communication, interpretation or for processing. It is known to the expert in information technology what is meant by the term “data”.

In the prior art, touch screens are also described as area sensors. They enable input by touching with fingers.

Operatively connected designates in the sense of the invention especially that the transmitting and/or receiving device is connected or linked to the touch screen at least temporarily in such a manner that data can be exchanged between the touch screen and the transmitting and/or receiving device. Examples of operatively connected elements are, for example, the incandescent lamp and the light switch which are connected to one another via an operation or a function. Operatively connected in the simplest sense means especially that something is connected to one another mechanically at least temporarily. Furthermore, it can be connected—e.g. electronically—in such a manner that energy and/or information is transmitted (for example without there being a mechanical link), i.e. two elements are arranged or linked (to one another) in such a manner that the desired effect is implemented.

The touch screen or at least a part area thereof is brought into contact with the plate of the transmitting and/or receiving device. In the sense of the invention, bringing into contact means that there is preferably no free space especially between the plate and the touch screen. In the sense of the invention, bringing into contact means that especially the transmitting and/or receiving device is in functional interaction with the touch screen and there is preferably no free space. That means the plate is preferably in touch contact with the touch screen. However, it may also be preferred that there is no direct contact between the plate and the touch screen but there is only an approach which is sufficient for triggering a data transmission. This is the case especially when intermediate layers and/or substrates prevent the direct contact between plate and touch screen.

The plate can serve as receptacle for receiving at least the electrically conductive areas and can have any shape (e.g. angular, round, rectangular, square etc.). The material of the plate is preferably selected from the group comprising plastic, paper, cardboard, wooden material, foil, compound material, grass, ceramics, circuit board material, textiles, leather or a combination thereof. The plate consists especially of an electrically non-conductive material which is preferably rigid. It is possible to use transparent and/or opaque materials.

It may be preferred, for example, that the plate having the especially at least one electrically conductive area is covered by an electrically non-conductive layer or cover layer which protects the plate or generally the transmitting and/or receiving device from dirt and applications of force. Furthermore, the layer or cover layer can be designed in such a manner that it does not damage the scratch-sensitive area of the touch screen but protects it. The cover layer is preferably made of an electrically non-conductive material such as paper, plastic, textile, foam, rubber and/or the same material as the plate and can be printed or coated with a layer of color or lacquer and/or a wax layer. The cover layer can be preferably a layer of adhesive, a paper layer, a color layer, a lacquer layer and/or a foil. Naturally, it is also conceivable to apply combinations of the aforementioned.

On the plate of the transmitting and/or receiving device which, in the sense of the invention, can be called an electrode plate, at least one electrically conductive area is applied. The shape of the area is arbitrary and can be designed in different configurations. Thus, for example, round, angular or oval areas or combinations such as, in particular, circular rings can be present on the plate. Complex geometric shapes can also be implemented or a number of individual areas can be combined with one another. It may be preferred that on the plate a number of electrically conductive areas are applied, the areas being arranged preferably individually, in pairs or in functional groups on the plate. Preferably, shape, orientation, number, alignment, distance and/or position of the areas can vary. Areas created with a certain layout are also known as structured areas to the expert. The structuring of the areas is carried out in the respective manufacturing process.

It may also be preferred to arrange a number of electrically conductive areas in the form of one or more arrays on the plate so that one array or a number of arrays are provided by conductive areas not directly electrically connected to one another. In the sense of the invention, an array designates an arrangement of electrically conductive areas on an electrically non-conductive substrate (of the plate).

It is also preferred that the electrically conductive areas are arranged individually, in pairs or in functional groups on the plate. In the sense of the invention, functional groups designate especially an arrangement of areas which are advantageously used for selectively changing the influence of the interaction with the touch screen or the device having a touch screen. This includes, for example, the reducing, enlarging, generating, oscillating, changing to and fro, displacing or progressing of interactions which surprisingly trigger touch events, i.e. generate, delete and/or change touch points. Deleting means in the sense of the invention especially that the conditions for indicating a touch point are no longer met, e.g. by dropping below a threshold value. These touch events surprisingly render the interactions analyzable for the touch screen or the device having a touch screen in the form of data and/or signals. The interaction between touch screen and input means is controlled electronically and at the same external influences (e.g. external positioning and distance do not change significantly).

The electrically conductive areas can be advantageously applied by means of additive processes such as printing, stamping, PVD and CVD processes, galvanic processes or subtractive processes such as laser structuring, brushing, milling etc. Semi-additive methods such as, e.g., selective etching processes after previous full-area material application on a non-conductive substrate can also be advantageous. In one embodiment, the electrically conductive areas are applied to the plate by means of a transfer process. In this context, a foil transfer process, especially a thermal transfer process is especially preferred. Such methods are known to the expert. Naturally, all other methods for applying an electrically conductive area can also be used.

At least one electrically conductive area is preferably applied structured to the plate. In the sense of the invention, structured means, in particular, that the electrically conductive area does not cover the plate completely but partially. By linking the electrical conductivity with the structured application it has been surprisingly possible to achieve a selective interaction of the electrically conductive areas of the plate with a touch screen.

The electrically conductive layer is preferably a metal layer, a layer containing metal particles, a layer containing electrically conductive particles, electrically conductive polymer layer or a layer of at least one combination of these layers. In general, any material can be used which is electrically conductive. Furthermore, metal-organic materials consisting of a compound of metal and carbon can also be used. In the sense of the invention, metals designate especially chemical elements which, in contrast to the non-metals in the periodic table, are on the left of the diagonal separation line beginning with the element beryllium (second group) up to polonium (sixteenth group), and their alloys and intermetallic compounds (comprising Laves phases, Heusler phases, Zintl phases, Hume-Rothery phases, NiTi, Co5, Nb3Sn or Ni3Al) having characteristic metallic properties. Metals comprise, among others, aluminum, lead, chromium, iron, gold, indium, cobalt, copper, magnesium, manganese, molybdenum, sodium, nickel, silver, titanium, tungsten, zinc or tin. Furthermore, metal oxides such as, for example, indium tin oxide can be used. This is particularly advantageous because it is electrically conductive but also transparent.

In the sense of the invention, polymers designate especially a substance which is composed of a collective of chemically uniformly structured macromolecules which, as a rule, however, differ with regard to the degree of polymerization, molecular weight and chain length (polymer molecules). The polymers are preferably electrically conductive. In such uniformly polymer-containing substances, all macromolecules are preferably structured identically and only differ by their chain length (degree of polymerization). Such polymers can be called polymer homologs. Polymers can be selected from the group comprising inorganic polymers, metal-organic polymers, full- or part-aromatic polymers, homopolymers, copolymers, biopolymers, chemically modified polymers and/or synthetic polymers. Polymers selected from paraphenylene, polyacetylene, polypyrrol, polythiophene, polyaniline (PANI) and PE-DOT are especially preferred.

Electrically conductive substances are furthermore especially soot or graphite particles. Soot describes a phenomenon of carbon which forms in the case of incomplete combustion or thermal splitting of vaporous carbon-containing substances. Soot can be used in powdery or granulated form. It is also possible to use soot preparations, for example as liquid, pasty or solid soot solvent concentrates in which the soot is uniformly dispersed. Depending on the method of production and raw material, soot can also contain hydrogen, nitrogen or oxygen in addition to carbon. Soot has an excellent pigment characteristic and an insolubility in all solvents, resistance against most chemicals, lightfastness, high depth and intensity of color. Graphite, in the sense of the invention, designates especially a stable modification of carbon. Due to its layer-like structure, graphite is a good conductor.

At least one electrically conductive area represents preferably the interface to the touch screen and is preferably arranged in a spatial vicinity of it. In the sense of the invention, a spatial vicinity designates especially that there is direct contact or indirect contact and at least one electrically conductive area is in functional interaction with the touch screen. This interaction can be achieved by various physical operating principles or combinations of these, e.g. capacitive, inductive, electromagnetic or electronic. The respective interaction depends on the type of touch screen actually present, i.e. on the touch screen technology. The function of the electrically conductive area is preferably the triggering of at least one touch event on the touch screen. In the sense of the invention, a touch event designates especially a triggering of an event on the touch screen. By this means, for example, data can be transmitted from the transmitting and/or receiving device to the touch screen or to the device having the touch screen.

It is preferred that the transmitting and/or receiving device comprises at least one transmitting means, one receiving means, one control unit and/or evaluation electronics. By means of the transmitting means, data can be sent from the transmitting device to the touch screen via at least one electrically conductive area of the plate. This provides for a secure and rapid type of data transmission. It was completely surprising that the data transmission can take place with any type of a touch screen so that a universal applicability of the transmitting and/or receiving device is ensured.

Preferred transmitting and/or receiving means comprise means of short-distance radio engineering (WPAN—wireless personal area network) selected from the group comprising Bluetooth, WLAN or infrared and especially means for capacitive and/or optical methods. Preferred receiving means comprise preferably resistive sensors, inductive sensors, differential transformers, inductive travel sensors, eddy current sensors, inductive proximity switches, magnetic field sensors, magnetoelastic sensors, capacitive sensors, piezoelectric sensors, optoelectronic sensors or electrochemical sensors.

The transmitting and/or receiving means can be integrated at different positions in the transmitting and/or receiving device. For example, it may be preferred that the plate has openings or recesses into which transmitting and/or receiving means, especially sensors, are integrated. It may additionally be preferred that the plate has openings behind which sensors are arranged. Due to the preferred position of the sensors, a rapid and efficient data transmission can be established between the touch screen and transmitting and/or receiving device. The transmitting and/or receiving means can have their own power supply or be linked to the power supply of the transmitting and/or receiving device.

In the prior art, thin-film sensors are described which have little thickness and can be applied flexibly to an underground. Such transmitting and/or receiving means or generally transmitting and/or receiving means having little thickness can also be arranged on or underneath the plate, as a result of which the total thickness of the transmitting and/or receiving device can be reduced considerably.

The transmitting and/or receiving device can preferably have a number of transmitting and/or receiving means which are also called data communication means in the sense of the invention.

It is preferred that the system is used for the unidirectional or bidirectional transmission of data between a device having a touch screen and a transmitting and/or receiving device, there being a capacitive coupling between the device and the touch screen and this effecting a data input on the device having a touch screen. By means of the transmitting and/or receiving means, data can be transmitted from the transmitting and/or receiving device to the touch screen or to the device having the touch screen, but can also be received by the latter. That is to say, in a preferred embodiment, a bidirectional exchange of data is possible between the touch screen or the device having the touch screen, respectively, and the transmitting and/or receiving device. For this purpose, the transmitting and/or receiving device preferably has an evaluating unit which converts the signals received by the receiving means into processable data. It is preferred that the data transmitted by the device having the touch screen are converted into signals which are received by the sensors of the device and converted back into data by means of the evaluating electronics. In the sense of the invention, an evaluating unit designates electrical and electronic means which are present in the transmitting and/or receiving device and are used for processing the received signals and interpreting the data generated.

In a preferred embodiment, the transmitting and/or receiving device comprises at least:
a. one electrical conductor track,
b. one electrically conductive area,
c. one control unit for electronically controlling the electrically conductive area,
d. one internal or external power supply,
e. receiving means and/or
f. one evaluating unit, wherein
   the electrically conductive area is electrically connected to the control unit via at least one conductor track.

At least one electrically conductive area is preferably arranged patterned on the plate and connected via at least one conductor track, which is used for the electrical interconnection of at least one area, to the control unit.

By this means, the areas can be actuated electronically by the control unit during the sending of data to a touch screen and trigger a touch event on the touch screen. The device having the touch screen can convert the touch events into data by means of an evaluating unit. The transmitting and/or receiving device receives its electrical power preferably from a power supply which can have an internal or external origin. The power supply can be, for example, a battery, an accumulator, a solar cell, a piezoelectrical element, a capacitor or a combination thereof. The power supply is connected electrically to the control unit and supplies it with power. It may also be preferred that the power supply is rechargeable, exchangeable or replaceable by an external power system connection. For this purpose, the power supply has corresponding connecting terminals. However, the transmitting and/or receiving device can also receive energy from an external power supply so that the device preferably only has corresponding terminals in order to be connected to the corresponding power supply.

The power supply can be equipped preferably as a solar cell which can provide electrical energy by means of a light source. For this purpose, artificial or natural light sources can be utilized. It may also be preferred to utilize an “energy harvesting” method for supplying the transmitting and/or receiving device with power. For example, the energy could be provided by the touch screen which is in contact with the device. The device can also be supplied with electrical energy preferably by means of induction (e.g. an induction coil).

For example, every electrically conductive area has a downlead in the form of conductor tracks to the control unit. That is to say all downleads are preferably brought together in a control unit (e.g. a controller chip with external analog circuit) or a number of control units. The areas are therefore electrically connected to one another only via the control unit, there not being any direct electrical connection between the areas (except via the control unit). Conductor tracks preferably consist of an electrically conductive material and preferably produce an electrical connection.

The control unit of the transmitting and/or receiving device comprises preferably at least one digital and/or analog circuit and the control unit can consist of one or more components. A digital circuit is preferably a microcontroller but can also be an ASIC, an FPGA or a discrete digital circuit of logic gates, semiconductor components, electromechanical or mechanical components or a combination thereof. The digital circuit is used for generating the data or the codes to be transmitted and converting these into digital or analog signals which are forwarded either directly or via the analog circuit via at least one electrically conductive link to at least one electrically conductive area which, in the sense of the invention, can also be called electrode. An analog circuit is used for signal shaping and can contain, for example, a high-pass filter, a low-pass filter, an element for direct-voltage decoupling, an operating-point setting (bias voltage) or a charge pump. For each of the electrically conductive links to in each case one of the electrically conductive areas, there are preferably similar analog circuits, but there can also be different designs of the analog circuit for the individual links to the electrically conductive areas. It is also preferred to mount a mechanical arrangement on the control unit which itself is controlled by a higher entity such as, for example, a user and opens and closes electrical bridges between the conductor tracks (relay construction).

It may be advantageous if the digital circuit of the control unit is an electronic, electromechanical, mechanical circuit or a combination of these.

The invention thus also relates to the use of the system for the unidirectional or bidirectional data transmission between a device having a touch screen and a transmitting and/or receiving device, wherein a capacitive coupling is effected between the device and the touch screen and this coupling produces a data input on the device having the touch screen. The system provides for rapid and secure data transmission between a transmitting and/or receiving device and a touch screen. By this means, it is possible, on the one hand, to send data from the touch screen to the receiving device and data from the transmitting device to the touch screen. The system can thus be applied in many ways, preferably it can be used for authorization and/or authentication.

It was completely surprising that the system can be used preferably for applications in numerous areas. These comprise, for example, gaming figures, identification, customer cards, immobilizers, access authorization for car/bike sharing, access authorization, random number generator, chip cards, car keys, keys, playing cards, collecting cards, goods logistics, goods tracking, digital classification systems, categorization, digital file card system, inlet, entry cards, access to closed areas both real and virtual, virtual contents, marketing applications, customer restraints, lotteries and raffles, member's passes, season tickets, payment applications, authenticity certificates, certificates, counterfeit protection measures, copy protection, signatures, delivery notes, objects within computer games, music/video/E-book downloads, bonus marks/programs, appliance controls or gift cards, without being limited to these.

In a special embodiment, the system can also be used as storage device in such a manner that data are sent via the device having the touch screen to the device which are stored in volatile or non-volatile memory in the device. It can thus be preferred that the transmitting and/or receiving device has means for storing data. The device having a touch screen can also advantageously call up data from the device by sending data to the device which, in turn, cause the control unit to send data stored in the device to the device having a touch screen.

To establish a simple and fast interaction between the touch screen and the transmitting and/or receiving device, it may be advantageous if the plate of the transmitting and/or receiving device, the cover layer or the transmitting and/or receiving device itself has visual, acoustic, tactile, haptic or mechanical positioning means in order to guarantee optimum positioning of the touch screen or of the device having the touch screen at or on the transmitting and/or receiving device. For example, the transmitting and/or receiving device can have a stop edge which serves to position the touch screen. Correct or wrong positioning can be conveyed to the user simply by visual, acoustic, tactile or haptic means.

In a preferred embodiment, an input and/or output system is integrated in the transmitting and/or receiving device and/or in a device containing the device. This is selected from the group comprising keyboard, mouse, joystick, graphics tablet, digital pen, game pad, scanner, cameras, MIDI keyboards, printer and display. The input systems can simplify the operation of the transmitting and/or receiving device. To connect the input and/or output systems to the transmitting and/or receiving device, the latter can have the terminals described in the prior art so that a connection can be established rapidly and in a simple manner. By means of the output systems, the data exchange between the touch screen or, respectively, the device having a touch screen, and the transmitting and/or receiving device can be observed or documented. For example, the progress of the data exchange can be indicated on a display which is connected to the device. In a preferred embodiment, the display can be integrated into a housing of the transmitting and/or receiving device. The display can also be constructed as touch screen so that it can act as input and output system.

In a preferred embodiment, the system can have means for data communication with other data transmission devices and/or data processing systems. A data processing system is especially called an electronic data processing system in the sense of the invention and comprises preferably computer, mainframe computer, server systems, database systems, information systems, process computer, digital measuring systems, DSP systems, microcontroller systems, compact controllers, embedded systems, mobile telephones, smart phones, tablets, digital answering machines, video conference systems and communication systems. The means for data communication provide for a data transmission of the transmitting and/or receiving device with the device having the touch screen and also with other data transmission devices and/or data processing systems, the connection being established especially by cableless or cable links, e.g. radio or light. However, it may also be preferred that the device itself represents a data processing system and/or is connected to a data processing system.

By means of the system, a wireless communication/data transmission between a mobile device having a touch screen and a transmitting and/or receiving device is surprisingly possible. Accordingly, the invention also relates to a method for data transmission between a device having a capacitive touch screen and a transmitting and/or receiving device, the device having at least one plate having at least one conductive area, comprising the following steps:

a. bringing the touch screen close to the plate having the conductive area, and

b. sending electrical signals from the device to the touch screen, namely activating the capacitive touch screen, especially electrodes of the touch screen, by means of capacitive coupling with the conductive areas of the plate, and

c. triggering touch events on the touch screen.

By means of the method, it is advantageously possible to transmit data between a touch screen, or a device having a touch screen, and the transmitting and/or receiving device, wherein the data exchange can take place unidirectionally or bidirectionally. The touch events are preferably allocated to an action of the data processing system or trigger this action. This action particularly applies to data processing systems which are not networked and especially preferably to networked data processing systems. The actions are system-typical or system- and application-related and comprise, for example, the activation and/or ending of an application, the changing of numeric values and/or text, the manipulation of graphics, the changing of data sets or the obtaining of access to data and/or information-related services, without being restricted to these.

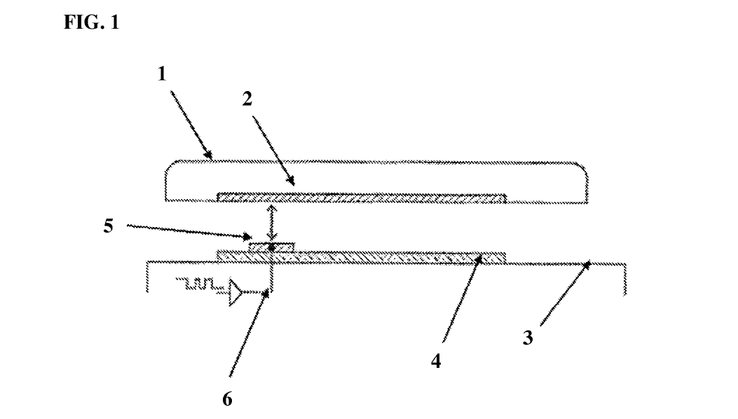

FIG. 1 shows a preferred system. The system comprises a device 1 having a touch screen 2, and a transmitting and/or receiving device 3 having a plate 4 having at least one electrically conductive area 5. The electrically conductive area 5 is preferably patterned, i.e. applied area by area to the plate 4 so that the area 5 does not completely cover the plate 4. The area 5 is preferably connected to a control unit (not shown) for electronic control 6. The plate 4 is preferably operatively connected to the touch screen 2 so that capacitive coupling takes place between the electrically activated area 5 and the touch screen 2, wherein a data exchange takes place between the touch screen 2 and the transmitting and/or receiving device 3, especially the electrically conductive area 5 (indicated by the arrow on both sides).

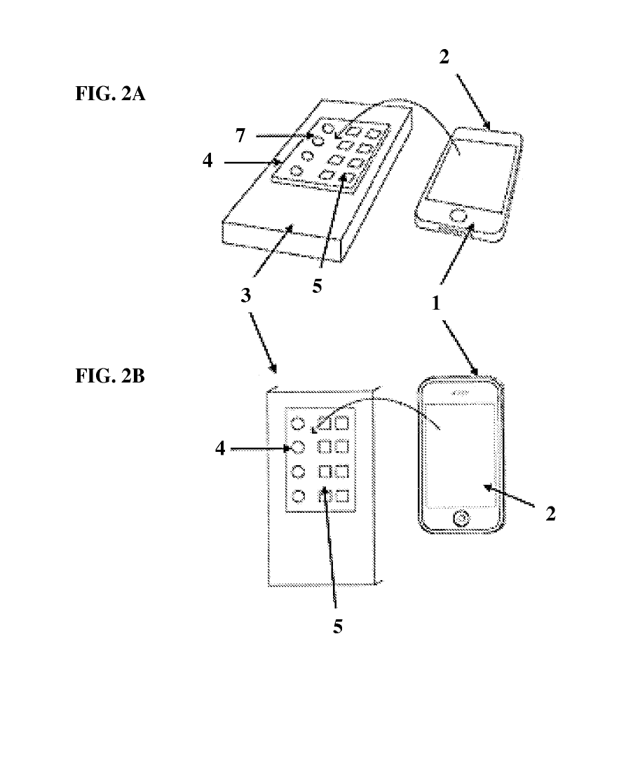

FIG. 2A and FIG. 2B represent a preferred interaction between a device 1 and the device. The transmitting and/or receiving device 3 can interact in any orientation with the device 1 or the touch screen 2, respectively. In order to simplify the positioning of the touch screen 2 on the transmitting and/or receiving device 3, it can have positioning means with the aid of which the device 1 can only be brought at or onto the transmitting and/or receiving device 3 in a defined orientation. For the interaction, only the touch screen 2 is brought into the vicinity or into contact with the device 3 or the plate 4 with the electrically conductive areas 5. The data exchange between the touch screen 2 and the transmitting and/or receiving device 3 can take place in unidirectional or bidirectional direction. The transmitting and/or receiving device 3 can have openings 7 or recesses into which transmitting and/or receiving means 8 (not shown) are installed.

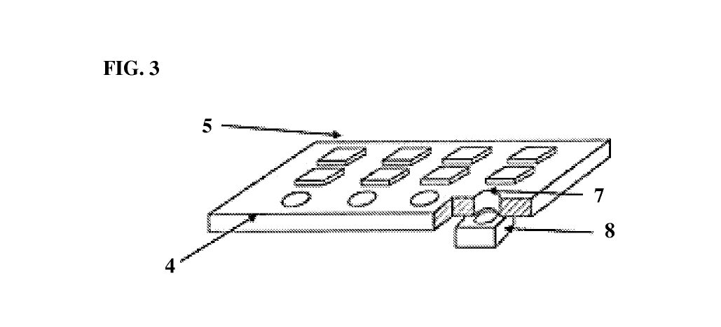

FIG. 3 shows a sectional representation of a plate 4 of a preferred variant of the embodiment. The plate 4 has preferably electrically conductive areas 5 and openings 7. The areas 5 are patterned, i.e. arranged area by area on the plate 4. Into the plate 4, openings 7 are integrated into which transmitting and/or receiving means 8 are inserted. However, it may also be advantageous that the plate 4 only has indentations into which the transmitting and/or receiving means 8 are inserted. Furthermore, it may be advantageous if the plate 4 which, in the sense of the invention, can also be called carrier, substrate or substrate layer, has openings 7, sensors being arranged behind the openings 7, i.e. on the side of the openings 7 which is opposite the area 5. By means of the transmitting and/or receiving means 8 which preferably can be optoelectrical sensors, signals from the touch screen 2 can be sent to the transmitting and/or receiving device 3. The signals can be, for example, optical, acoustic or other signals.

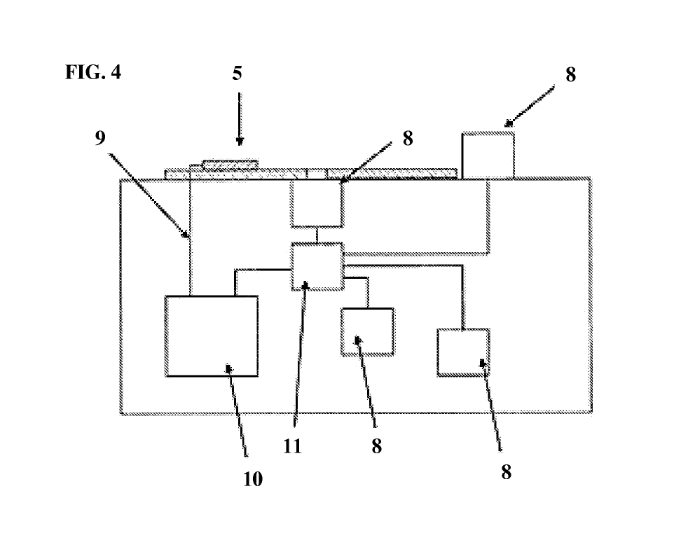

FIG. 4 represents an exemplary variant of the transmitting and receiving device 3 which has a number of receiving means 8. In this context, the control unit 10 is connected via conductor track 9 to the electrically conductive area 5 which engages in an operative connection with the touch screen 2 (not shown here). Furthermore, the system can receive signals via the other receiving means 8 from the device 1 having the touch screen. The receiving means 8 are connected here to the evaluating unit 11 for processing the received signals. The received signals are processed further by the evaluating unit 11 in order to obtain from these useful data which are finally forwarded to the control unit 10. A system in the configuration shown can have, apart from the further receiving means shown, also other transmitting means 8 in order to communicate with the device 1 (not shown) having the touch screen. The transmitting and/or receiving means 8 can be integrated at difference places in the transmitting and/or receiving device 3. Preferred transmitting and/or receiving means 8 comprise means for capacitive and optical methods and/or means of the short-distance radio technology (WPAN—wireless personal area network) selected from the group comprising Bluetooth, WLAN or infrared. Furthermore, resistive sensors, inductive sensors, differential transformers, inductive travel transducers, eddy current sensors, inductive proximity switches, magnetic field sensors, magnetoelastic sensors, capacitive sensors, piezoelectric sensors, optoelectronic sensors or electrochemical sensors are also preferred as receiving means.

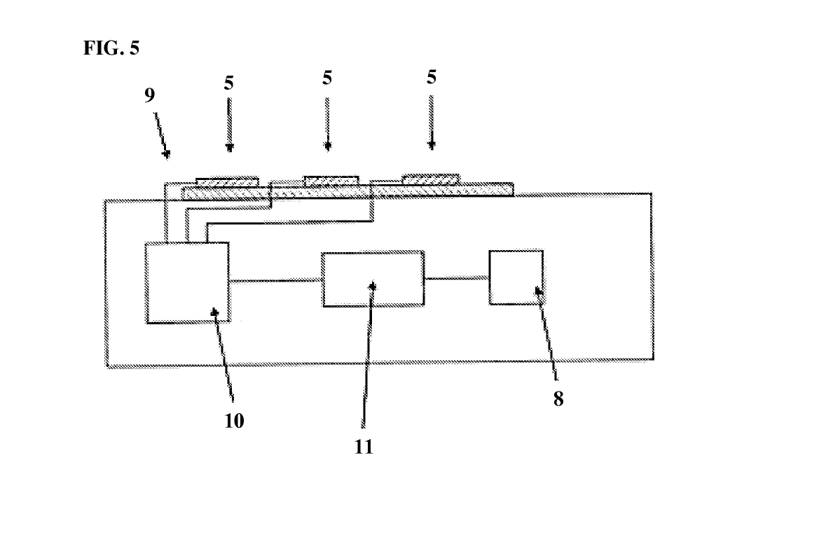

FIG. 5 shows a further structure of the system consisting of a control unit 10 which activates a number of conductive areas 5 via in each case one conductor track 9. This provides the option of establishing a number of operative connections with the touch screen 2 (not shown here), as a result of which, for example, a parallel transmission of a number of signals take place to the touch screen 2 for the purpose of a higher data transmission rate. Furthermore, a receiving means 8 is shown which is connected to the evaluating unit 11. A system in this exemplary configuration is capable of communicating bidirectionally with a device 1 (not shown) containing a touch screen.

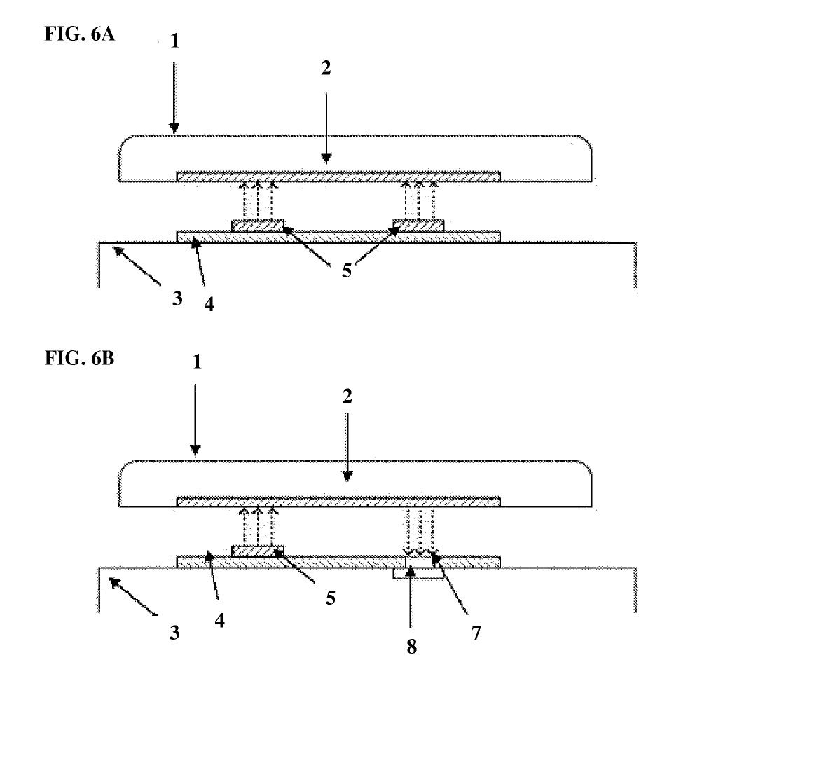

FIG. 6A and FIG. 6B show a unidirectional and bidirectional data exchange. The data exchange is represented by the dashed arrows. As soon as the touch screen 2 or the device 1 having the touch screen is operatively connected to the transmitting and/or receiving device 3, a data exchange can take place between the touch screen 2 and the electrically conductive areas 5 on the plate 4 of the transmitting and/or receiving device 3. In this context, data are preferably sent from the areas 5 to the touch screen 2 where touch events are correspondingly triggered, an evaluating unit 11 (not shown) of the device 1 converting the received signals into data. Furthermore, it may be advantageous that data are conveyed from the touch screen 2 to the transmitting and/or receiving device 3. For this purpose, transmitting and/or receiving means 8 can be integrated preferably in openings 7 which receive signals sent by the touch screen 2 and forward them to an evaluating unit 11 (not shown) which converts the signals into data.

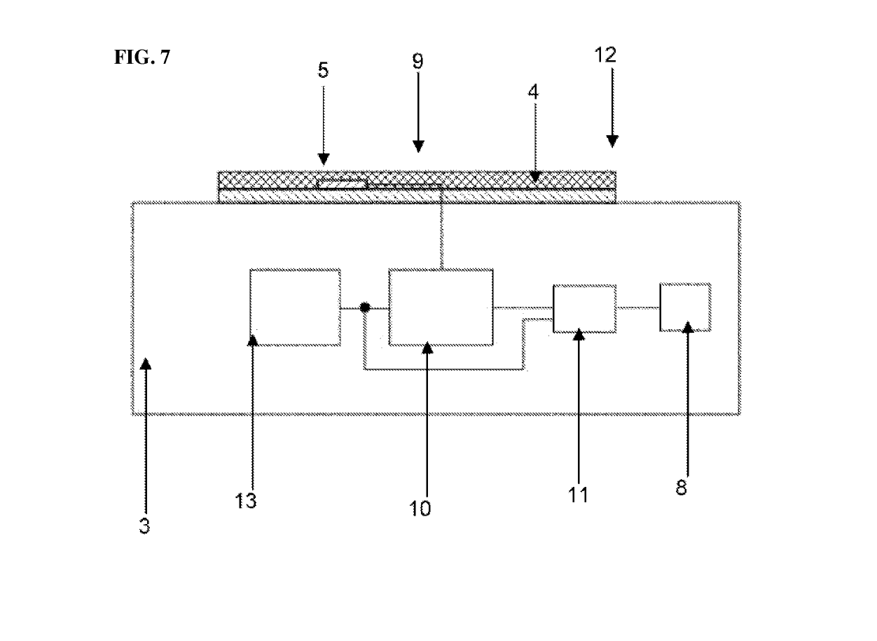

FIG. 7 shows a preferred transmitting and/or receiving device 3 having a cover layer 12. The transmitting and/or receiving device 3 has a plate 4 on which at least one electrically conductive area 5 is present. On the plate 4 having the area 5, a further layer can be applied in the form of a cover layer 12. The cover layer 12 protects the plate 4 and the area 5 against dirt and external applications of force. The area 5 is connected via conductor track 9 to a control unit 10 which preferably handles the electronic control of the area 5. The control unit 10 is preferably connected to an evaluating unit 11 or evaluating electronics which convert the received signals into data. The evaluating unit 11 and the control unit 10 are connected to a power supply 13. This can be an internal or external power supply 13.

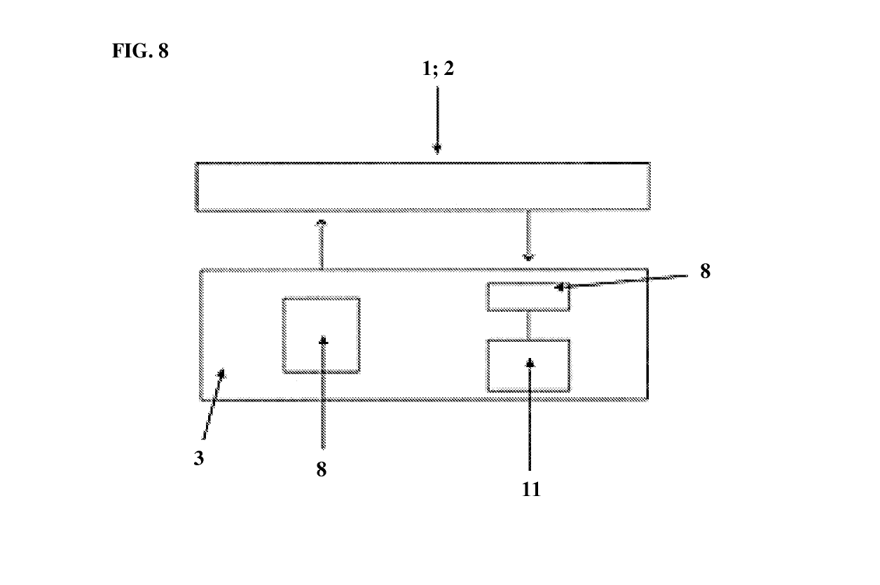

FIG. 8 shows a preferred data exchange. Between the touch screen 2 or, respectively, the device 1 having a touch screen, and the transmitting and/or receiving device 3, a unidirectional or bidirectional data exchange can take place. For this purpose, the transmitting and/or receiving device 3 has, apart from the electrically conductive areas 5 (not shown in the figure), a transmitting means 8, shown on the left in the figure, which sends signals to the touch screen 2, and a receiving means 8, as shown on the right in the figure, which can receive the signals from the touch screen 2. The signals can be received, for example, by receiving means 8 in the form of sensors which are arranged below the plate 4 (not shown). The sensors are connected to an evaluating unit 11 which converts the signals received from the touch screen 2 into data.

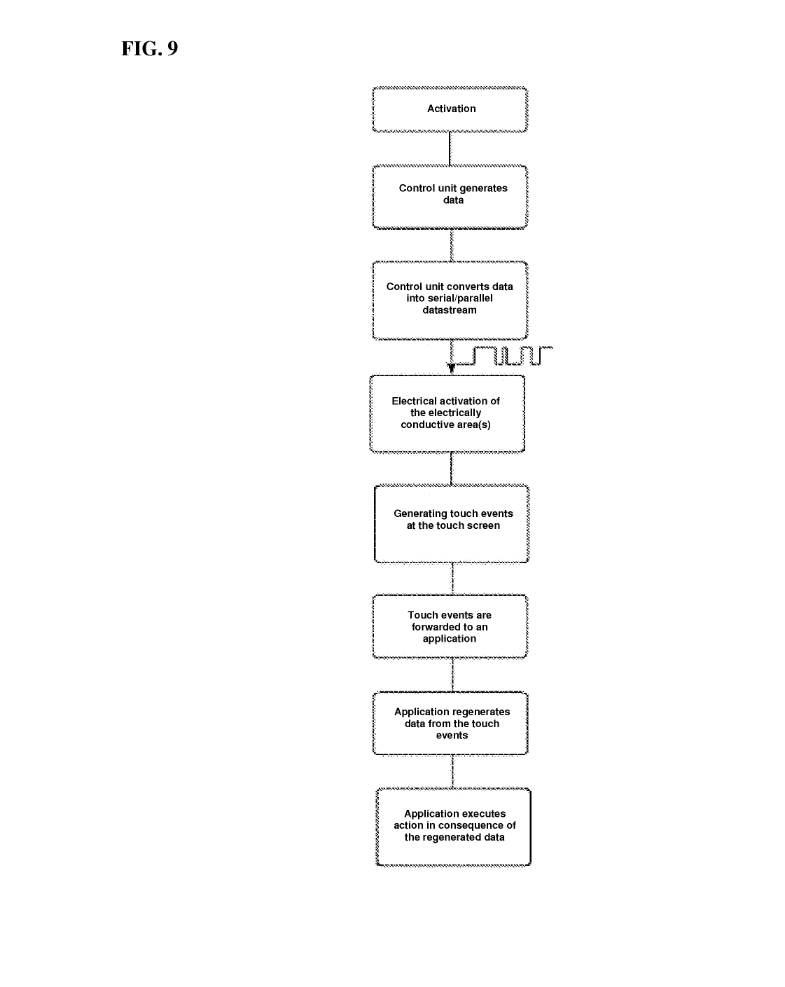

FIG. 9 shows a preferred sequence of a data exchange. When a touch screen, or a device having a touch screen, brought into contact with a transmitting and/or receiving device is present, a data exchange can take place between the touch screen and the device. For this purpose, the transmitting and/or receiving device is activated, the control unit generating data or receiving data from a data processing system. The data are converted into a serial/parallel datastream so that the electrically conductive areas can be electrically activated and the data can be sent to the touch screen. The electrically activated areas generate touch events on the screen which, in turn, are evaluated by an evaluating unit or forwarded to a corresponding application where data are generated from the touch events. By interpreting the data, the application can execute, for example, an action. The action can also comprise the sending of data, e.g. acknowledgement data, from the device having the touch screen to the transmitting and/or receiving device.

### LIST OF REFERENCE DESIGNATIONS

1 Device having a touch screen

2 Touch screen

3 Transmitting and/or receiving device

4 Plate

5 Electrically conductive area

6 Electronic control

7 Opening

8 Transmitting and/or receiving means

9 Conductor track

10 Control unit

11 Evaluating unit

12 Cover layer

13 Power supply

1. A system for transmitting data between a device having a touch screen and a transmitting and/or receiving device, the touch screen being a capacitive screen and the device having at least one plate having at least one electrically conductive area, wherein:
the plate is operatively connected to the touch screen and at least one area is activated.

2. The system as claimed in claim 1, wherein the transmitting and/or receiving device comprises at least one transmitting means, receiving means, one control unit and/or one evaluating unit.

3. The system as claimed in claim 1 wherein the plate having the area is covered by an electrically non-conductive layer.

4. The system as claimed in claim 1, wherein the device comprises at least:
a. one electrical conductor track,
b. one electrically conductive area,
c. one control unit for electronically controlling the electrically conductive area,
d. one internal or external power supply,
e. receiving means and/or
f. one evaluating unit,
the electrically conductive area being connected electrically to the control unit via at least one conductor track.

5. The system as claimed in claim 4, wherein the control unit comprises at least one digital and/or analog circuit and the control unit consists of one or more components.

6. The system as claimed in claim 5, wherein the digital circuit of the control unit is an electronic, electromechanical, mechanical circuit or a combination of these.

7. The system as claimed in claim 1, wherein the electrically conductive areas are arranged individually, in pairs or in functional groups on the plate.

8. The system as claimed in claim 1, wherein the plate has openings into which sensors are integrated or behind which sensors are arranged.

9. The system as claimed in claim 8, wherein data sent by the device having the touch screen are converted into signals which are received by the sensors of the device and are reconverted into data by means of the evaluating unit.

10. The system as claimed in claim 9, wherein the data transmission is unidirectional or bidirectional.

11. The system as claimed in claim 1, wherein an input and/or output system is integrated into the device and/or into a device containing the device.

12. The system as claimed in claim 1, wherein the system has means for data communication with other data transmission facilities and/or data processing systems.

13. The system as claimed in claim 1, wherein the device itself represents a data processing system and/or is connected to a data processing system.

14. A method for data transmission comprising a system as claimed in claim 1, the device having at least one plate having at least one electrically conductive area, comprising the following steps:
a. bringing the touch screen close to the plate having the conductive area, and
b. sending electrical signals from the device to the touch screen, namely activating the capacitive touch screen, especially electrodes of the touch screen, by means of capacitive coupling with the conductive areas of the plate, and
c. triggering touch events on the touch screen.

15. The use of the system as claimed in claim 1 for the unidirectional or bidirectional data transmission between a device having a touch screen and a transmitting and/or receiving device, wherein a capacitive coupling is effected between the device and the touch screen and this coupling produces a data input on the device having a touch screen.

16. The use as claimed in claim 15, the system being used for authorization and/or authentication.

17. The use as claimed in claim 15, wherein for applications selected from the group consisting of gaming figures, identification, customer cards, immobilizers, access authorization for car/bike sharing, access authorization, random number generator, chip cards, car keys, keys, playing cards, collecting cards, goods logistics, goods tracking, digital classification systems, categorization, digital file card system, inlet, entry cards, access to closed areas both real and virtual, virtual contents, marketing applications, customer restraints, lotteries and raffles, member's passes, season tickets, payment applications, authenticity certificates, certificates, counterfeit protection measures, copy protection, signatures, delivery notes, objects within computer games, music/video/E-book downloads, bonus marks/programs, device controls and gift cards.
